(19) United States
(12) Patent Application Publication
(10) Pub. No.: US 2012/0290572 A1
(43) Pub. Date: Nov. 15, 2012

(54) INFORMATION PROCESSING APPARATUS, INFORMATION PROCESSING METHOD, AND COMPUTER READABLE MEDIUM STORING PROGRAM FOR INFORMATION PROCESSING

(75) Inventor: Kazuto HAYASHI, Kanagawa (JP)

(73) Assignee: FUJI XEROX CO., LTD., Tokyo (JP)

(21) Appl. No.: 13/284,502

(22) Filed: Oct. 28, 2011

(30) Foreign Application Priority Data
May 12, 2011 (JP) 2011-106939

(51) Int. Cl. G06F 17/30

(52) U.S. Cl. 707/736; 707/E17.014

(57) ABSTRACT

An information processing apparatus includes a receiver unit that receives record information related to a record, the record including information about an item and time and date information about time and date on which the item has been preformed, a classifying unit that classifies the received record information into at least one of multiple series, a standard event specifying unit that specifies a standard event on a per series basis, the standard event serving as a standard in the generation of a structure, a structuring unit that performs a structuring operation on the classified record information in accordance with the standard event specified by the standard event specifying unit, a pattern extraction unit that extracts a common pattern from multiple pieces of record information that are structured in the structuring operation of the structuring unit, and an output unit that outputs the pattern extracted by the pattern extraction unit.

### CROSS-REFERENCE TO RELATED APPLICATIONS

This application is based on and claims priority under 35 USC 119 from Japanese Patent Application No. 2011-106939 filed May 12, 2011.

### BACKGROUND

(i) Technical Field

The present invention relates to an information processing apparatus, an information processing method, and a computer readable medium storing a program for information processing.

(ii) Related Art

Information processing techniques are available to process record information including information about an item and time and date information on time and date on which the item has been performed.

### SUMMARY

According to an aspect of the invention, there is provided an information processing apparatus. The information processing apparatus includes a receiver unit that receives record information related to a record, the record including information about an item and time and date information about time and date on which the item has been preformed, a classifying unit that classifies the record information received by the receiver unit into at least one of multiple series, a standard event specifying unit that specifies a standard event on a per series basis, the standard event serving as a standard in the generation of a structure, a structuring unit that performs a structuring operation on the record information classified by the classifying unit in accordance with the standard event specified by the standard event specifying unit, a pattern extraction unit that extracts a common pattern from multiple pieces of record information that are structured in the structuring operation of the structuring unit, and an output unit that outputs the pattern extracted by the pattern extraction unit.

### BRIEF DESCRIPTION OF THE DRAWINGS

Exemplary embodiments of the present invention will be described in detail based on the following figures, wherein:

FIG. 1 is a module configuration of an exemplary embodiment of the present invention;

FIG. 2 is a flowchart of a process of the exemplary embodiment;

FIGS. 3A through 3C illustrate record information received by a record information receiving module;

FIGS. 4A and 4B illustrate a first structuring process of a series 1 of a case a;

FIGS. 5A and 5B illustrate a second structuring process of a series 2 of the case a;

FIGS. 6A and 6B illustrate a third structuring process of a series 3 of the case a;

FIGS. 7A and 7B illustrate a first structuring process of a series 1 of a case b;

FIGS. 8A and 8B illustrate a second structuring process of a series 2 of the case b;

FIGS. 9A and 9B illustrate a third structuring process of a series 3 of the case b;

FIGS. 10A and 10B illustrate a first structuring process of a series 1 of a case c;

FIGS. 11A and 11B illustrate a second structuring process of a series 2 of the case c;

FIGS. 12A and 12B illustrate a third structuring process of a series 3 of the case c;

FIG. 13 illustrates an example of a pattern extracted from the series 1;

FIG. 14 illustrates an example of a pattern extracted from the series 2;

FIG. 15 illustrates an example of a pattern extracted from the series 3;

FIG. 16 illustrates an example of the pattern extracted from the series 3;

FIG. 17 illustrates process information resulting from linking standard event information;

FIG. 18 illustrates process information resulting from linking the standard event information; and

FIG. 19 is a block diagram illustrating a hardware structure of a computer implementing the exemplary embodiment.

### DETAILED DESCRIPTION

An exemplary embodiment of the present invention is described below.

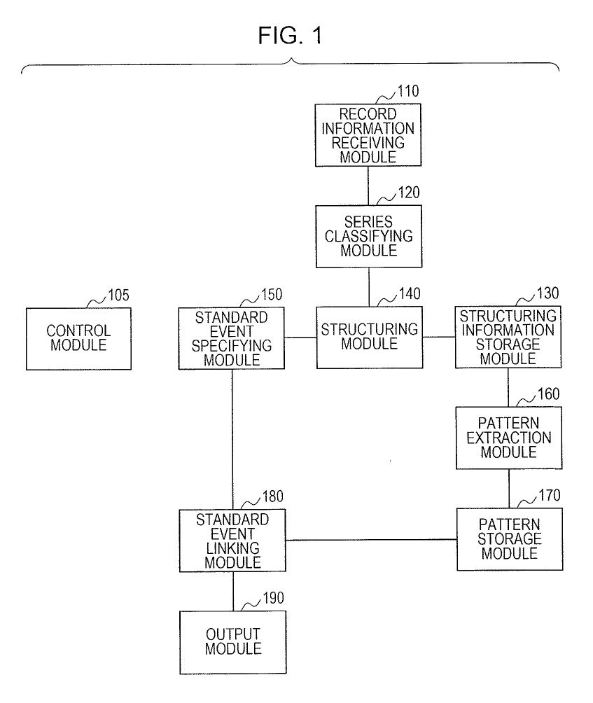

FIG. 1 illustrates a conceptual module configuration of the exemplary embodiment.

The word “module” refers to a generally logically separable software element (such as a computer program) or a component as a hardware element. The module of each exemplary embodiment refers to not only a module in a computer program but also a module in a hardware structure. The discussion of the exemplary embodiments also serves as the discussion of computer programs for causing the modules to function (including a program that causes a computer to execute each step, a program that causes the computer to function as an element, and a program that causes the computer to implement each function), a system and a method. In the discussion that follows, the phrases “stores information,” “causes information to be stored,” and other phrases equivalent thereto are used. If an exemplary embodiment is a computer program, these phrases are intended to express “causes a memory device to store information” or “controls a memory device to cause the memory device to store information.” The modules may correspond to the functions in a one-to-one correspondence. In a software implementation, one module may be composed of one program or multiple modules may be composed of one program. One module may be composed of multiple programs. Multiple modules may be executed by a single computer. A single module may be executed by multiple computers in a distributed environment or a parallel environment. One module may include another module. In the discussion that follows, the word “connection” refers to not only a physical connection but also a logical connection (such as an exchange of data, instructions, and data reference relationship). The word “predetermined” means that something is decided in advance of a process of interest. The word “predetermined” is thus intended to refer to something that is decided in advance of a process of interest in the exemplary embodiment. Even after a process in the exemplary embodiment has started, the word “predetermined” refers to something that is decided in advance of a process of interest depending on a condition or a status of the exemplary embodiment at the present point of time or depending on a condition or status heretofore continuing down to the present point of time.

The word “system” and the word “apparatus” refer to an arrangement where multiple computers, a hardware structure, and an apparatus are interconnected via a communication network (including a one-to-one communication connection). The word “system” and the word “apparatus” also refer to an arrangement that includes a single computer, a hardware structure, and an apparatus. The word “system” and the word “apparatus” have the same definition and are interchangeable with each other. The system in the context of the exemplary embodiment does not include a social system that is a social arrangement formulated by humans.

At each process performed by a module, or at one of the processes performed by a module, information as a process target is read from a memory device, the information is then processed, and the process results are then written onto the memory device. A description of the reading of the information from the memory device prior to the process and the writing of the processed information onto the memory device subsequent to the process may be omitted as appropriate. The memory devices may include a hard disk, a random access memory (RAM), an external storage medium, a memory device connected via a communication line, and a register within a central processing unit (CPU).

Record information to be herein handled is mainly record information that is managed in medical institutions. The exemplary embodiment is thus directed to an analysis assisting system that extracts information through analysis from the record information of medical care and medication.

Related art is discussed for easy understanding of the exemplary embodiment. Several medical institutions are reviewing diagnostic process in order to improve the quality of diagnosis and assure the soundness in the management of the institution. The institutions are different in terms of condition, for example, in terms of the age distribution of the patients and area characteristics, and the diagnostic process is thus different from institution to institution. The medical process is to be improved and standardized in view of the situation of each medical institution. To this end, in-depth study is performed on the diagnostic process currently in operation.

The diagnostic process is typically complex. Even if the range of the diagnostic process is narrowed to disease and operation, studying each case and grasping the entire picture of the diagnostic process are very difficult. A technique of getting the overview of the diagnostic process performed on multiple cases is available. In accordance with the technique, medical records are plotted in a matrix of two axes of item and time and date of the item, and the frequency of occurrence of each item in the records is studied.

This technique has difficulty in coping with the case in which the date of each item suffers from fluctuations. A technique of coping with the case in which the date of each item suffers from fluctuations is also available. In this technique, the frequency of occurrence is represented by a distribution function in the direction of time and date, and counting is obtained through integration calculation. The date of implementation is handled in an unclear fashion, and a medication process in an unlikely order may be extracted in some cases. If the permissible range of the fluctuations in the implementation date may be widened to one day or longer, workload is increased. The possibility that a diagnostic process in a non-existent order is extracted is increased. It is difficult to cope with the case in which the date of the item suffers from fluctuations.

The case in which the time and date of the item suffers from fluctuations refers to the case that the time and date on which the item is to be implemented is unfixed. For example, the actual implementation time and date may be different from the scheduled implementation time and date. The implementation time and date may not be scheduled, and the item may be implemented depending on the situation. These two cases also fall within the range of the case in which the time and date of the item suffers from fluctuations. More specifically, the item is implemented depending on patient and situation. Given the same medical treatment, the implementation time and date may be different on a different patient. The number of implementations of the item may also be different.

An information processing apparatus of the exemplary embodiment extracts a pattern from the record information. As illustrated in FIG. 1, the information processing apparatus includes control module 105, record information receiving module 110, series classifying module 120, structuring information storage module 130, structuring module 140, standard event specifying module 150, pattern extraction module 160, pattern storage module 170, standard event linking module 180, and output module 190.

The control module 105 controls a process order, and data exchanging of each module.

The record information receiving module 110 is connected to the series classifying module 120. The record information receiving module 110 receives record information related to a record of information of an item and time and date information of time and date on which the item has been performed. The record information includes at least the item and time and date information. The item refers to a name of a specific process such as an operation, a treatment, an examination, and a prescription of medicine, performed by a medical institution. The items may be classified into a series (the series is described below). The time and date information of the time and date on which the item has been performed is also received in map with the item. The time and date information may include not only information of the time and date, but also information of the year, the month, the minute, the second, and an amount of time shorter than the second. Conversely, the time and date information may only include information of the date or the hour. The time and date may be information indicative of an anteroposterior relationship between items, or an interval from the implementation time and date of any given item.

The record information receiving module 110 may receive the recording information in response to an operation input entered by a user on a user interface such as a keyboard, a mouse, a touchpanel or the like. The record information receiving module 110 may read the record information via a communication line from a data source stored on a predetermined data server.

The series classifying module 120 is connected to the record information receiving module 110 and the structuring module 140. The series classifying module 120 classifies the record information received by the record information receiving module 110 into at least one series. The series is a type in accordance with which the record information is classified. For example, the series include an operation, a treatment, an examination, and a medication.

The classifying refers to an operation of assigning the record information to at least one series. The record information is classified to any of the series, and the record information and the series may have a relationship of 1 to N (N is an integer of 1 or higher). For example, the record information may be classified to two series. In the discussion that follows, one piece of record information is classified into one series.

In the classifying operation, the record information is mapped to the series in accordance with a predetermined selection criterion. For example, a table mapping the series and the item serves as the selection criterion. Such a table is prepared. A series to which an item in the record information belongs is searched for, and the hit series is attached to the item.

The standard event specifying module 150 is connected to the structuring module 140, and the standard event linking module 180. The standard event specifying module 150 specifies, on a per series basis, an event serving as a standard in the generation of a structure. The event serving as the standard is hereinafter referred to as a standard event.

A user may specify the standard event using a user interface device such as a keyboard, a mouse, and/or a touchpanel. A predetermined standard event may be input by reading that standard event.

The structuring module 140 is connected to the series classifying module 120, the structuring information storage module 130, and the standard event specifying module 150. The structuring module 140 performs a structuring operation on the record information classified by the series classifying module 120 in accordance with the standard event specified by the standard event specifying module 150. The structuring operation refers to an operation of structuring the record information into a tree. The tree structure includes a leaf representing an item in the record information, and nodes representing a standard event, and an intermediate period representing an interval from the standard event. Information identifying the series may be added to the tree structure. The tree structure constructed through the structuring operation is stored onto the structuring information storage module 130.

The structuring information storage module 130 is connected to the structuring module 140, and the pattern extraction module 160. The structuring information storage module 130 stores the structured record information with the series mapped thereto.

Optionally, the record information structured by the structuring module 140 may be transferred to the pattern extraction module 160 not via the structuring information storage module 130.

The pattern extraction module 160 is connected to the structuring information storage module 130 and the pattern storage module 170. The pattern extraction module 160 extracts a common type from among multiple pieces of record information structured in the structuring operation of the structuring module 140. The type is hereinafter referred to as a pattern. The “multiple pieces of structured record information” stored on the structuring information storage module 130 may be used. Even in such a case, the information stored on the structuring information storage module 130 is the “multiple pieces of record information structured in the structuring operation of the structuring module 140.” In either case, the process target of the pattern extraction module 160 is the “multiple pieces of record information structured in the structuring operation of the structuring module 140.” The extracted pattern is extracted on a per series basis, and is then to be linked by the standard event linking module 180 later. The extracted pattern is thus referred to as a pre-link partial pattern. Information indicating event information in which the partial pattern occurs, and the series from which the partial pattern is extracted is mapped to the partial pattern. The partial pattern with the information mapped thereto is stored on the pattern storage module 170.

If the record information managed in the medical institution is to be handled, the pattern extraction module 160 extracts a pattern common to the items performed on multiple patients.

The pattern storage module 170 is connected to the pattern extraction module 160, and the standard event linking module 180. The pattern storage module 170 stores the pattern extracted by the pattern extraction module 160. More specifically, the pattern storage module 170 stores the partial pattern together with the information mapping the partial pattern to the series.

Optionally, the pattern extracted by the pattern extraction module 160 may be transferred to the standard event linking module 180 not via the pattern storage module 170.

The standard event linking module 180 is connected to the standard event specifying module 150, the pattern storage module 170, and the output module 190. In accordance with the standard event specified by the standard event specifying module 150, the standard event linking module 180 links multiple patterns extracted by the pattern extraction module 160. The “extracted pattern” from the pattern storage module 170 may be used. Even in such a case, the patterns stored on the pattern storage module 170 are the “multiple patterns extracted by the pattern extraction module 160.” In either case, the process target of the standard event linking module 180 is the “multiple patterns extracted by the pattern extraction module 160.”

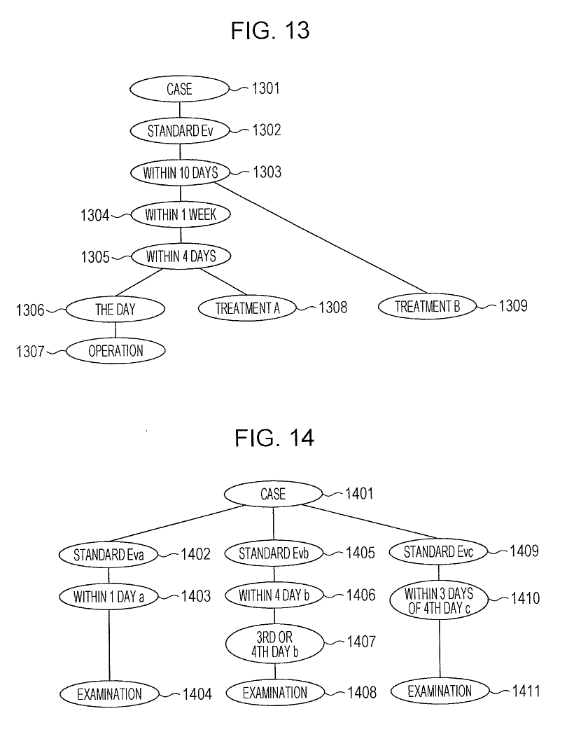

Using relation information of the standard event on each series, the standard event linking module 180 generates information into which partial patterns of the series are linked. More specifically, patterns illustrated in FIGS. 13-16 are linked.

Of the patterns extracted by the pattern extraction module 160, the standard event linking module 180 may also link patterns, having the same set of items occurring in the patterns, in accordance with the relationship of the standard event.

Optionally, the standard event linking module 180 may link, to a position within the structure of the pattern of the standard event of the series, a partial structure below that standard event of another pattern.

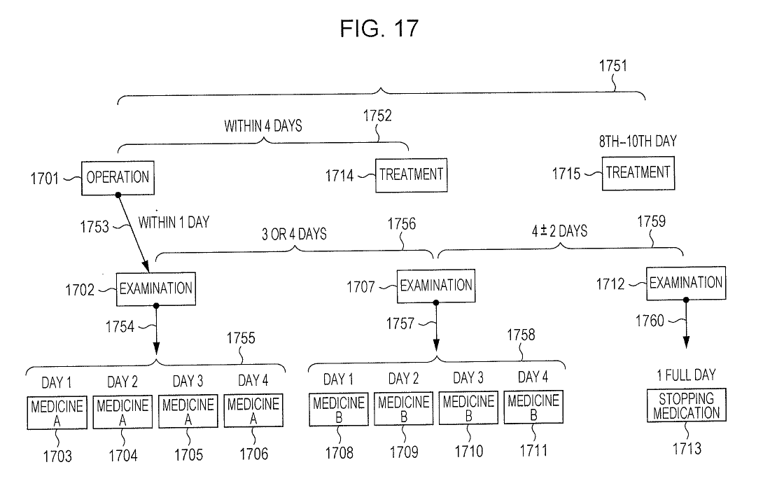

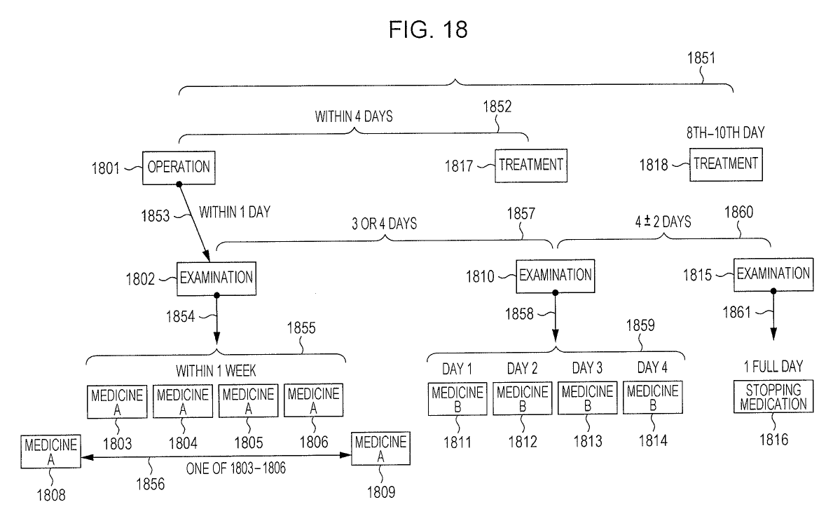

As a specific example of linking results, patterns of FIGS. 13 through 16 are linked into tree structures of FIGS. 17 and 18.

The pattern extracted by the pattern extraction module 160 may be transferred to the output module 190 without being processed by the standard event linking module 180.

The output module 190 is connected to the standard event linking module 180. The output module 190 outputs the pattern extracted by the pattern extraction module 160 or the pattern linked by the standard event linking module 180. The output operation performed by the output module 190 includes printing an image of the generated tree structure on a printer, displaying the image of the generated tree structure on a display, writing the information of the tree structure on a database of a data server, storing the information of the tree structure on a computer readable medium such as a memory card, and/or transferring the information of the tree structure to another information processing apparatus.

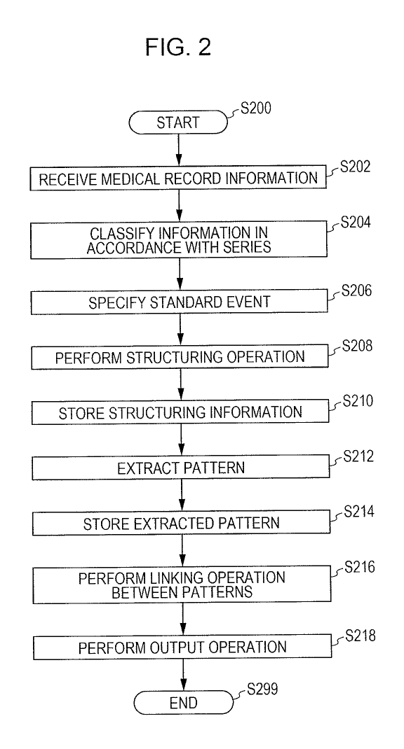

FIG. 2 is a flowchart of the process of the exemplary embodiment. The flowchart is described below with reference to a specific example.

In step S202, the record information receiving module 110 receives the record information related to medical care.

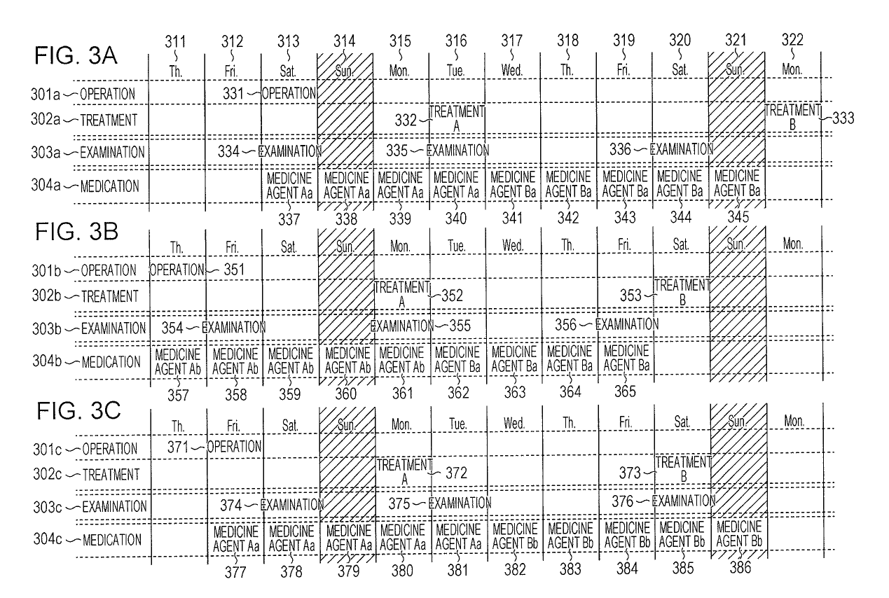

FIGS. 3A through 3C illustrate an example of the record information of the medical care received by the record information receiving module 110.

FIGS. 3A through 3C illustrate the record information of operations, examinations, and medications of three cases (three patients). A lateral direction of FIGS. 3A through 3C denotes time and date, and a hatched column denotes a holiday.

As illustrated in FIG. 3A, operation 331, and examination 334 are performed and medicine agent Aa 337 is prescribed on the first day (Saturday 313). The next day (Sunday 314) is a holiday on which medicine agent Aa 338 is prescribed only. On the next day (day 315), medicine agent Aa 339 is prescribed only. On the day (Tuesday 316) three days later from the operation, treatment A 332 and examination 335 are performed and medicine agent Aa 340 is prescribed. Throughout 3 days thereafter (Wednesday 317 through Friday 319), medicine agent Ba is prescribed (medicine agent Ba 341 through medicine agent Ba 343). On the seventh day (Saturday 320) from the operation, examination 336 is performed and medicine agent Ba 344 is prescribed. The next day (Sunday 321) is a holiday on which medicine agent Ba 345 is prescribed only. On the next day (Monday 322), treatment B 333 is performed only. FIGS. 3B and 3C also illustrate similar medical care.

The data structure of the record information may be a table structure or may be a list structure.

Each record of the record information related to the medical care includes information identifying a patient and a hospitalization of the patient, information identifying a specific treatment and medication, and information identifying the implementation time and date of the specific treatment and medication. The record information receiving module 110 receives the record information of the medical care including these pieces of information, and transfers the record information to the series classifying module 120.

In step S204, the series classifying module 120 classifies the record information on a per series basis.

In accordance with a predetermined criterion, the series classifying module 120 classifies the record information of the medical care into multiple series. The standard event is identified on a per series basis. This operation may be performed by a user. Optionally, standard event information of each series and information of a structuring method are pre-stored on a memory, and these pieces of information may be read. Also, the memory may store multiple pieces of standard event information of each series, and multiple pieces of information of the structuring method. The user may specify the standard event information and the information of the structuring method for selection.

The record information of the medical care of FIGS. 3A through 3C is classified into three series as described below.

(1) Operation and treatment

### (2) Examination

### (3) Medication

In step S206, the standard event specifying module 150 specifies the standard event.

In step S208, the structuring module 140 performs the structuring operation.

The structuring module 140 acquires the record information of the medical care of each case, and the standard event information of each series from the standard event specifying module 150. In the example discussed here, the structuring module 140 acquires the standard event and structuring information on a per series basis as described below.

The standard events of the series are described below.

(1) Standard event of the series: Series of operation and/or series of treatment (one or both of the series of operation and the series of treatment)

The first operation is set to be the standard event.

(2) Standard event of the series: Series of examination

The first operation is set to be a standard event a, the first treatment after the operation is set to be a standard event b, and the second treatment after the operation is set to be a standard event c.

(3) Standard event of the series: Series of medication

The first operation is set to be a standard event a, the first examination after the operation is set to be a standard event b, and the second examination after the operation is set to be a standard event c.

The structuring of the series is described below.

(a) Structuring of the series: Series of operation and/or series of treatment (one or both of the series of operation and the series of treatment)

The series is structured using relative time and date from the implementation date of the standard event, and a range of the relative time and date.

(b) Structuring of the series: Series of examination

The series is structured using relative time and date from the implementation date of the standard event, and a range of the relative time and date.

(c) Structuring of the series: Series of medication

The series is structured using relative time and date from the implementation date of the standard event, and a range of the relative time and date.

The structuring module 140 structures, on a per series basis, the record information of the medical care received from the record information receiving module 110.

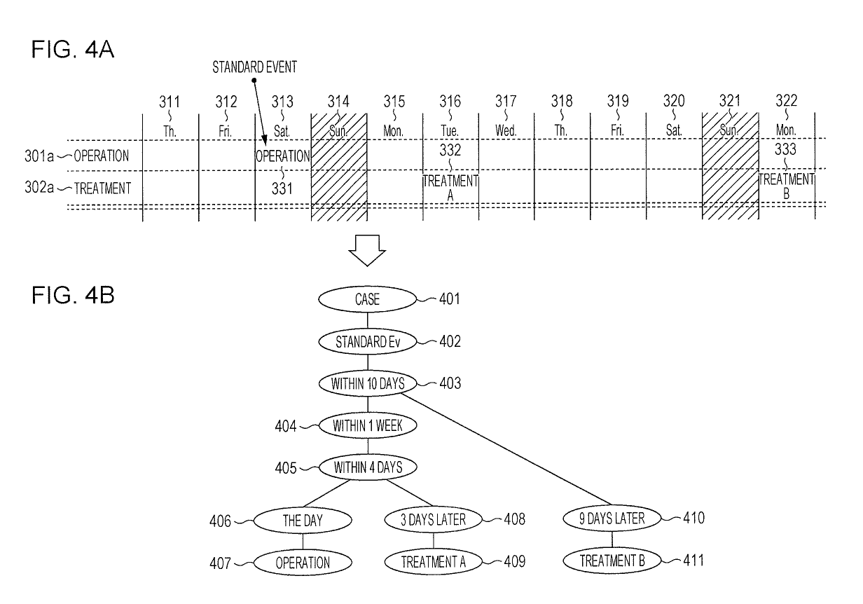

As illustrated in FIG. 3A, the series of operation and the series of treatment (hereinafter referred to a series 1) is structured as illustrated in FIG. 4B. A node representing the relative time and date from the day of the operation and a node representing a range of the relative time and date are added in the tree structure of FIG. 4B. FIG. 4A illustrates information for structuring extracted from FIG. 3A.

The record information is structured with operation 331 serving as the standard event using the relative time and date, and the range of the relative time and date. More specifically, case 401 is a root, and a node of standard Ev 402 under the case 401 is a standard event. A relative time and date range node 403 of within 10 days from the standard event is placed under the standard Ev 402. A relative time and date range node 404 within 1 week and a relative time and date node 410 of 9 days later are placed under the node 403 of within 10 days. A relative time and date range node 405 of within 4 days is placed under the node 404 of within 1 week. A relative time and date node 406 of the day and a relative time and date node 408 of 3 days later are placed under the node of 405 of within 4 days. A leaf 407 of operation of the record information is placed under the node 406 of the day. A leaf 409 of treatment A of the record information is placed under the node 408 of 3 days later. A leaf 411 of treatment B of the record information is placed under the node 410 of 9 days later. The nodes of relative time and date and the nodes of the range of the relative time and date are predetermined. The nodes of relative time and date and the nodes of the range of the relative time and date may be predetermined together with the standard event. (The same is true of the tree structures discussed below).

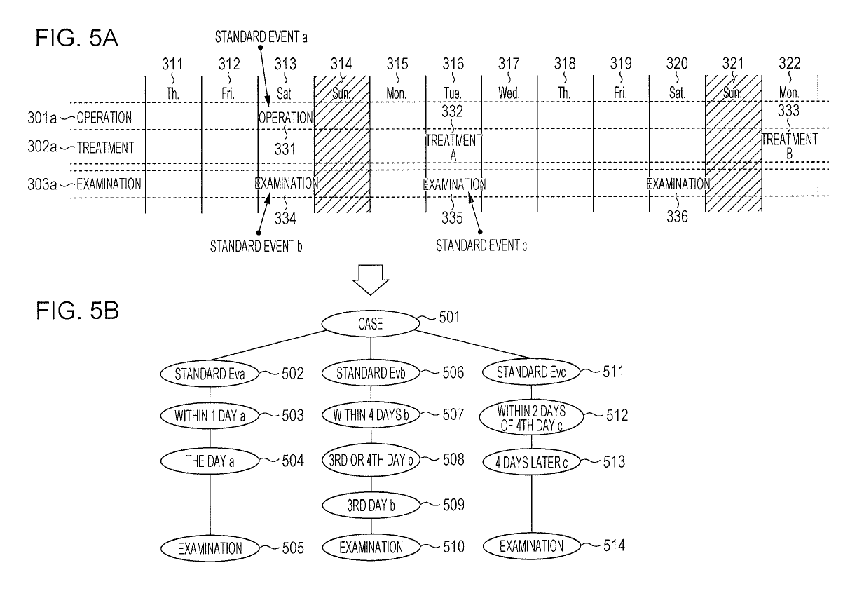

The series of the examination of FIG. 3A (hereinafter referred to as a series 2) is structured as illustrated in FIG. 5B. FIG. 5A illustrates information for structuring extracted from FIG. 3A.

The standard events are operation 331 of the series 1, and the first two examinations of the series 2 (examination 334 and examination 335). Structured are information of the first examination including the relative time and date from the standard event a (operation 331), information of the second examination including the relative time and date from the standard event b (examination 334), and information of the third examination including the relative time and date from the standard event c (examination 335). More specifically, case 501 is a root. Placed under the case 501 are as standard events a node 502 of standard Eva, a node 506 of standard Evb, and a node 511 of standard Evc. A relative time and date range node 503 of (within 1 day) a (representing within 1 day from the standard event a) is placed under the node 502 of standard Eva. A relative time and date node 504 of (the day) a (representing of the standard event a) is placed under the node 503 of (within 1 day) a. A leaf 505 of the record information for the examination is placed under the node 504 of (the day) a. A relative time and date range node 507 of (within 4 days) b from the standard event b is placed under the node 506 of standard Evb. A relative time and date range node 508 of (third or fourth day) b from the standard event b is placed under the node 507 of (within 4 days) b. A relative time and date node 509 of (the third day) b is placed under the node 508 of (the third or fourth day) b. A leaf 510 of the record information for the examination is placed under the node 509 of (the third day) b. A relative time and date range node 512 of (within 2 days of the fourth day) c from the standard event c is placed under standard event Evc 511. A relative time and date node 513 of (4 days later) c is placed under the node of within 3 days of (the fourth day) c. A leaf 514 of the record information for the examination is placed under the node 513 of (4 days later) c.

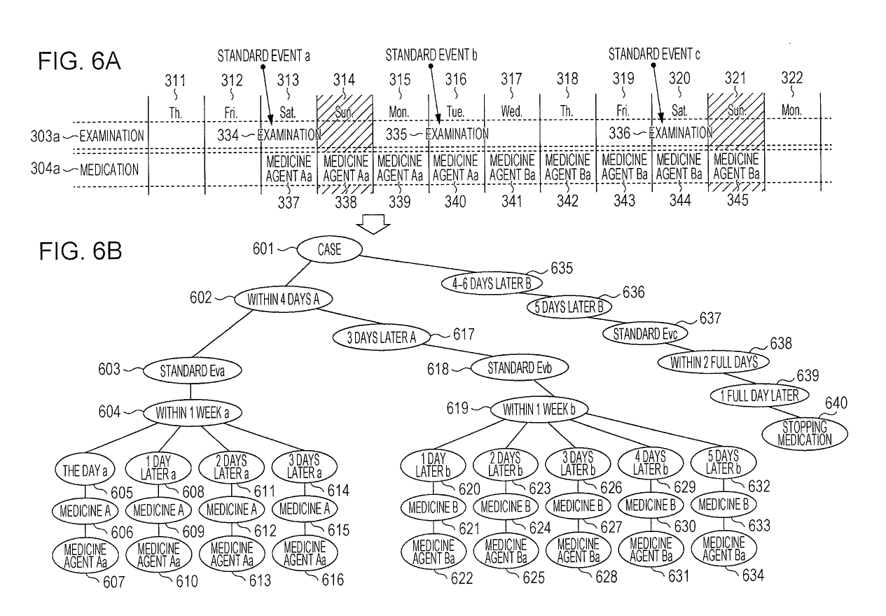

A series of medication of FIG. 3A (hereinafter referred to as a series 3) is structured as illustrated in FIG. 6B. FIG. 6A illustrates information for structuring extracted from FIG. 3A. A node having a label of a medicine class name “medicine A” is connected to an actual medicine agent name Aa. A node having a label of a medicine class name “medicine B” is connected to an actual medicine agent name Bb. The structuring is performed with the label having a broader concept and placed above the specific medicine agent name. A conversion process between the label and the specific medicine agent name may be performed using a table that maps a label having the broader concept to a specific medicine agent name. Referring to the table, the specific medicine name is converted to the broader concept label. The conversion process is performed in order to cover variations in the specific medicine agent name. A node 640 of stopping medication indicating the date on which the medication is terminated is also additionally structured.

The standard events include three examinations of the series 2 (examination 334, examination 335, and examination 336). Structured herein are information related to medicine agent Aa including the relative time and date from the standard event a (examination 334), information related to medicine agent Ba including the relative time and date from the standard event b (examination 335), and information related to the medication stopping 640 including the relative time and date from the standard event c (examination 336). More specifically, a case 601 is the root. Placed under the case 601 are a relative time and date range node 602 of (within 4 days) A from the standard event a and a relative time and date range node 635 of (4 through 6 days later) B. Placed under the node 602 of (within 4 days) A are a relative time and date range node 617 of (3 days later) A from the standard event a, and a node 603 of standard Eva as a standard event. A relative time and date range node 604 of (within 1 week) a from the standard event a is placed under the node 603 of standard Eva. Placed under the node 604 of (within 1 week) a are a relative time and date node 605 of (the day) a of the standard event a, a relative time and date node 608 of (1 day later) a, a relative time and date node 611 of (2 days later) a, and a relative time and date node 614 of (3 days later) a. A node 606 of medicine name A as a class name of medicine agent is placed under the node 605 of (the day) a. A leaf 607 of the record information of medicine agent Aa is placed under the node 606 of the medicine A. Placed similarly under the node 608 of (1 day later) a, the node 611 of (2 days later) a, and the node 614 of (3 days later) a are a node 609 of the medicine A and a leaf 610 of the medicine agent Aa, a node 612 of the medicine A and a leaf 613 of the medicine agent Aa, and a node 615 of the medicine A and a leaf 616 of the medicine agent Aa, respectively. A node 618 of standard Evb as a standard event is placed under the node 617 of (3 days later) A from the standard event a. A relative time and date node range 619 of (within 1 week) b from the standard event b is placed under the node 618 of standard Evb. Placed under the node 619 of (within 1 week) b are a relative time and date node 620 of (1 day later) b, a relative time and date node 623 of (2 days later) b, a relative time and date node 626 of (3 days later) b, a relative time and date node 629 of (4 days later) b, and a relative time and date node 632 of (5 days later) b. A node 621 of medicine name B as a class name of medicine agent is placed under the node 620 of (1 day later) b. A leaf 622 of the record information of medicine agent Ba is placed under the node 621 of the medicine B. Placed similarly under the node 623 of (2 day later) b, the node 626 of (3 days later) b, and the node 629 of (4 days later) b, and the node 632 of (5 days later) b are a node 624 of the medicine B and a leaf 625 of the medicine agent Ba, a node 627 of the medicine B and a leaf 628 of the medicine agent Ba, a node 630 of the medicine B and a leaf 631 of the medicine agent Ba, and a node 633 of the medicine B and a leaf 634 of the medicine agent Ba, respectively. A relative time and date range node 636 of (5 days later) B from the standard event a is placed under the node 635 of (4 through 6 days later) B. A node 637 of standard Evc as a standard event is placed under the node 635 of (5 days later) B. A relative time and date range node 638 of within 2 full days from the standard event c is placed under the node 637 of standard Evc. A relative time and date node 639 of 1 full day later is placed under the node 638 of within 2 full days. A leaf 640 of medication stopping (information indicating the day on which medication is complete) is placed under the node 639 of 1 full day.

The nodes above the node 603 of standard Eva, the node 618 of standard Evb, and the node 637 of standard Evc indicate the relationship between the standard events. Such nodes may be omitted. The nodes below the node 603 of standard Eva, the node 618 of standard Evb, and the node 637 of standard Evc indicate the relationship in the relative time and date and the relative time and date range in the standard events thereof.

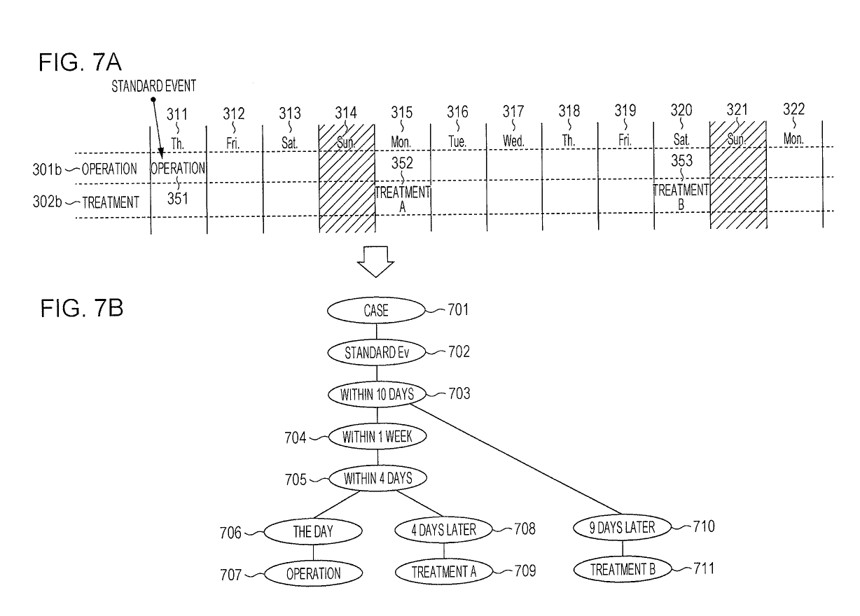

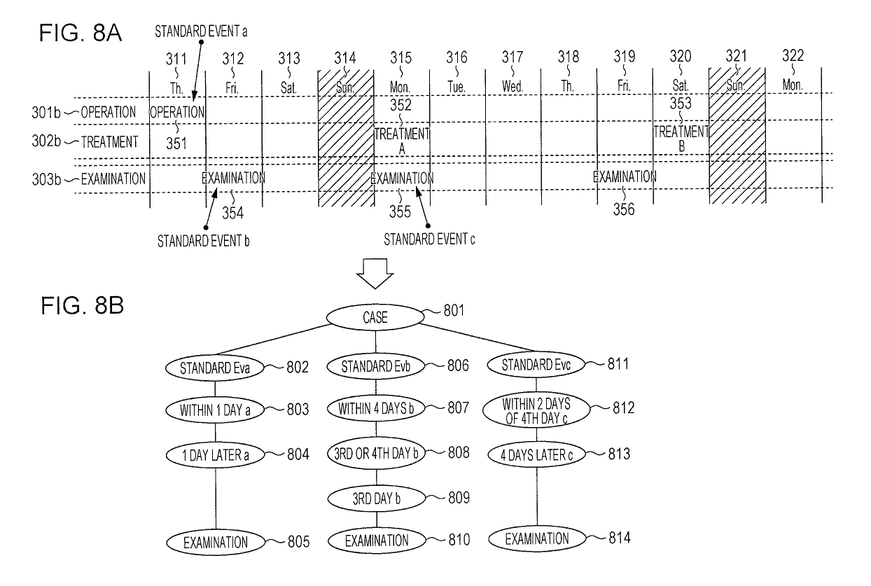

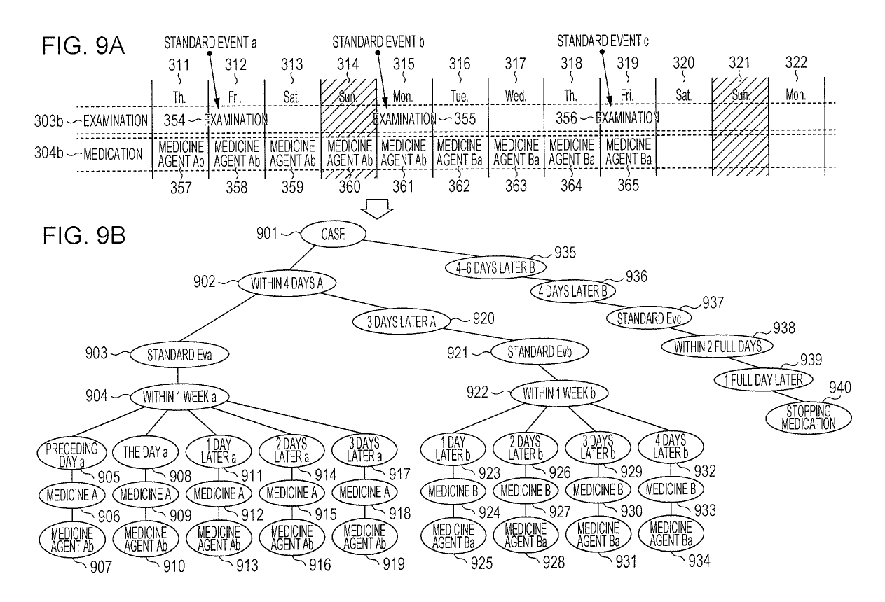

Similarly, the series of operation and the series of treatment of FIG. 3B are structured as illustrated in FIG. 7B. The series of examination is structured as illustrated in FIG. 8B. The series of medication is structured as illustrated in FIG. 9C.

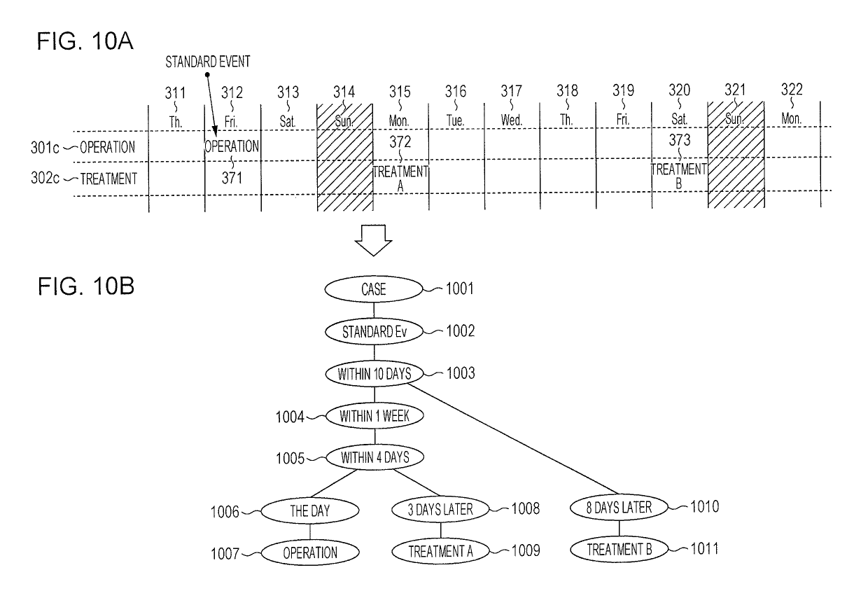

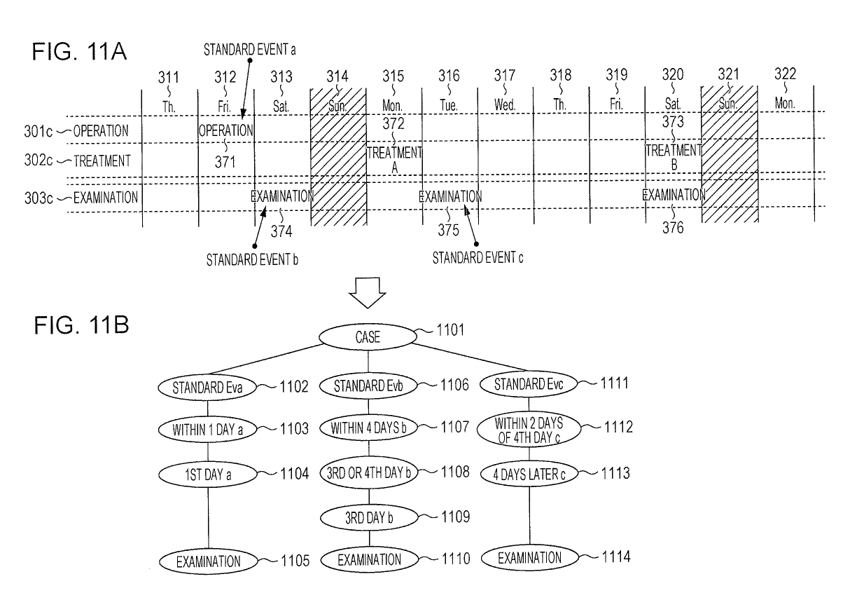

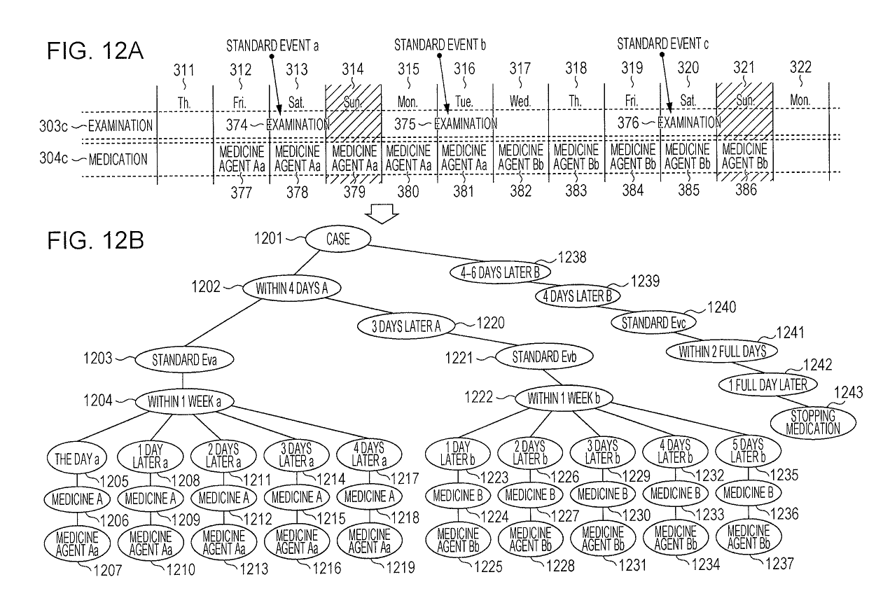

Similarly, the series of operation and the series of treatment of FIG. 3C are structured as illustrated in FIG. 10B. The series of examination is structured as illustrated in FIG. 11B. The series of medication is structured as illustrated in FIG. 12B.

In step S210, the structuring information storage module 130 stores the structuring information.

In step S212, the pattern extraction module 160 extracts a pattern.

The pattern extraction module 160 extracts a partial structure pattern from information structured on a per series basis. If information is structured into a tree in the exemplary embodiment, the pattern may be extracted using techniques such as TreeMiner, Dryade, MB3-miner, or TRIPS.

FIG. 13 illustrates an example of pattern that is a partial structure commonly shared by and extracted from the three tree structures, i.e., the tree structure of FIG. 4B, the tree structure of FIG. 7B, and the tree structure of FIG. 10B.

Similarly, FIG. 14 illustrates an example of pattern that is a partial structure commonly shared by and extracted from the three tree structures, i.e., the tree structure of FIG. 5B, the tree structure of FIG. 8B, and the tree structure of FIG. 11B.

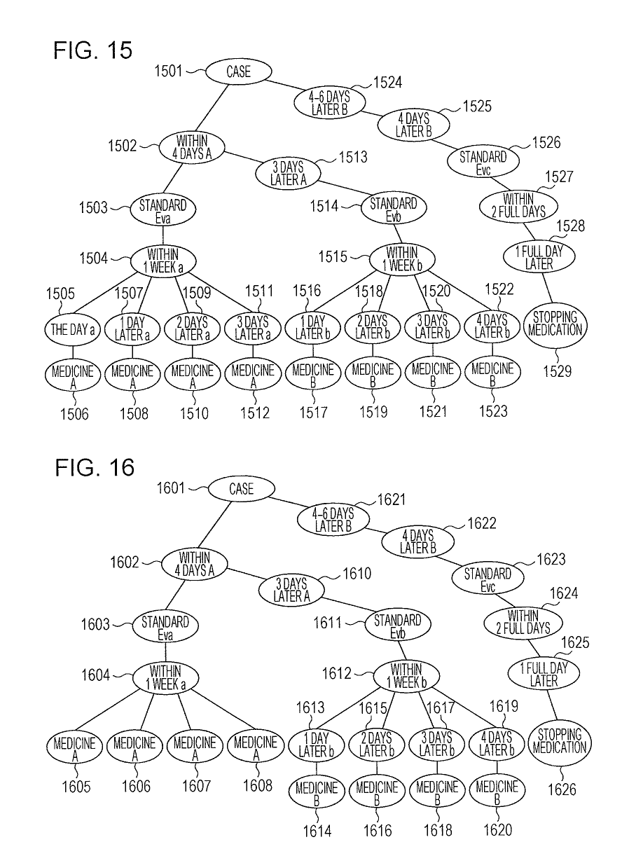

Similarly, FIG. 15 illustrates an example of pattern that is a partial structure commonly shared by and extracted from the three tree structures, i.e., the tree structure of FIG. 6B, the tree structure of FIG. 9B, and the tree structure of FIG. 12B.

Since the tree structure of FIG. 15 has a partial structure formed of the nodes common to the three tree structures (of FIG. 6B, FIG. 9B, and FIG. 12B), an extracted pattern includes only the classification of medicine not the medicine agent name.

Another example of the pattern extraction is illustrated. The tree structure of FIG. 16 is generated from the three tree structures (of FIG. 6B, FIG. 9B, and FIG. 12B). In the pattern, nodes of “medicine A” for the 4 days (nodes 1605-1608 of medicine A) are placed and connected to a node 1604 of (within 1 week) a without nodes identifying the relative dates (node 1505 of (the day) a, node 1507 of (1 day later) a, node 1509 of (2 days later) a, and node 1511 of (3 days later) a in FIG. 15). If a structure common to two of the three tree structures (the tree structures of FIG. 9B and FIG. 12B) is extracted, the number of nodes of “medicine A” placed below and connected to the node 1604 of (within 1 week) a is five.

In step S214, the pattern storage module 170 stores the extracted pattern.

In step S216, the standard event linking module 180 performs a linking operation between the patterns.

The standard event linking module 180 links the extracted patterns being identical in a set of cases (i.e., the patterns generated from the record information of multiple patients and having the same set of items appearing within the patterns) in accordance with the relationship of the standard events, and then transfers the linking results to the output module 190.

For example, two tree structures may be respectively linked in accordance with relation information 1 and relation information 2. The relation information 1 indicates that information of a node 1307 of operation and two treatments (node 1308 of treatment A and node 1309 of treatment B) within the tree structure of FIG. 13 is related to a standard of time node (node of (within 1 day) a) within the tree structure of FIG. 14. The relation information 2 indicates that information of examinations (node 1404 of examination, node 1408 of examination, and node 1411 of examination) within the tree structure of FIG. 15 is related to a standard of the time and date node (node 1504 of (within 1 week) a) within the tree structure of FIG. 15. More specifically, the relation information 1 relates the node 1307 of operation in the series of operation and treatment (series 1) to (the time and date information) a (node 1403 of (within 1 day) a) in the series of examination (series 2). The relation information 2 relates the node 1404 of examination (first examination) in the series of examination (series 2) to (the time and date information) a (node 1504 of (within 1 week) a) in the series of medication (series 3). In another example of relating an item (a node as a leaf) within one tree structure to a node as a standard event within another tree structure, the relation information 1 may relate the node 1307 of operation in the series of operation and treatment (series 1) to the node 1402 of standard Eva in the series of examination (series 2), and the relation information 2 may relate the node 1404 of examination (first examination) in the series of examination (series 2) to the node 1503 of standard Eva in the series of medication (series 3).

These pieces of information may be determined in advance, or may be determined in response to an operation by the user.

Using the relation information 1, the standard event linking module 180 links, to a position within a tree structure of a pattern of the standard event in the series 1, a partial structure below that standard event of another pattern in the series 2. Similarly, using the relation information 2, the standard event linking module 180 links, to a position within a tree structure of a pattern of the standard event in the series 2, a partial structure below that standard event of another pattern in the series 3. The patterns of the series 1, the series 2, and the series 3 are thus linked.

More specifically, the partial structure including the node 1403 of (within 1 day) a and lower nodes in the tree structure of the pattern of the series 2 (the tree structure of FIG. 14) is linked to the position of the node 1307 of operation in the tree structure of the pattern of the series (the tree structure of FIG. 13). Similarly, the partial structure including the node 1503 of standard Eva and lower nodes in the tree structure of the pattern of the series 3 (the tree structure of FIG. 15) is linked to the position of the node 1404 of examination in the tree structure of the pattern of the series 2 (the tree structure of FIG. 14).

FIG. 17 illustrates process information resulting from linking the standard event information. The process information is generated from information of nodes included in the patterns extracted from each series (the patterns illustrated in FIGS. 13 through 15) and information resulting from calculating the information of the relative time and date and the relative time and date range. The process information thus indicates horizontally connected information of series, i.e., information of the relationship between series. For example, the information resulting from calculation is the time and date information (i.e., within 4 days) in relations 1751 through 1760.

FIG. 18 illustrates another example of process information resulting from linking the standard event information. As illustrated in FIG. 18, information illustrated in FIG. 15 and information illustrated in FIG. 16 are linked to the series 3. Medicines A of 1703 through 1706 under relation 1755 in the lower left portion of FIG. 17 indicate day 1 through day 4. Medicines A of 1803 through 1806 under relation 1855 in the lower left portion of FIG. 18 indicate simply within 1 week from node 1802 of examination. Relation 1856 indicates one of medicines A of 1803 through 1806 enclosed by medicine A of 1808 and medicine A of 1809.

In step S218, the output module 190 performs an output operation. For example, the output module 190 displays graphs illustrated in FIGS. 17 and 18 or the like on a display or the like.

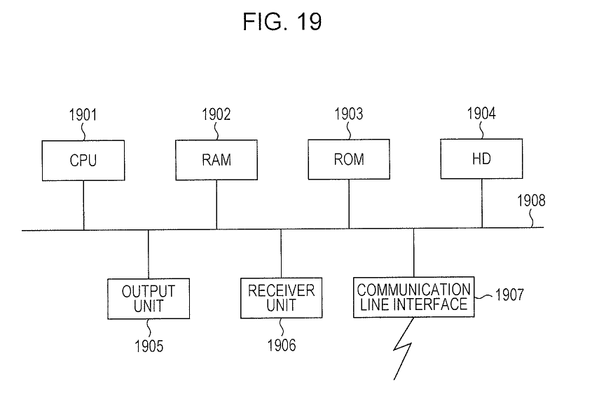

A hardware structure of a computer executing a program as the exemplary embodiment is illustrated in FIG. 19. Specifically, the computer may be a personal computer or a server. The computer may include as a processor a central processing unit (CPU) 1901, and, as memory devices, a random-access memory (RAM) 1902, a read-only memory (ROM) 1903, and HD 1904. The HD 1904 is a hard disk, for example. The CPU 1901 executes programs including the control module 105, the type classifying module 120, the structuring module 140, the pattern extraction module 160, and the standard event linking module 180. The computer thus includes the CPU 1901, the RAM 1902 storing the data and the program, the ROM 1903 storing a program starting the computer, and the HD 1904 as an auxiliary memory device. The computer further includes a receiving device 1906 receiving data in response to an operation performed on a keyboard, a mouse, or a touchpanel by a user, an output device 1905 such as a cathode ray tube (CRT) or a liquid-crystal display (LCD), a communication line interface 1907 such as a network interface card for connection with a communication network, and a bus 1908 interconnecting these elements for data exchange. Multiple computers may be connected via a network.

A software computer program as the exemplary embodiment may be read onto a hardware structure system and then executed with the hardware structure system in cooperation with software resources.

The hardware structure of FIG. 19 is illustrated for exemplary purposes only. The exemplary embodiment is not limited to the structure of FIG. 19. Any structure is acceptable as long as the structure implements the modules described with reference to the exemplary embodiment. For example, one of the modules may be constructed of a particular hardware structure (such as application specific integrated circuit (ASIC)). One of the modules may belong to an external system and may be connected to the system of the exemplary embodiment via a communication line. Multiple systems, each illustrated in FIG. 19, may be interconnected via a communication line such that the systems operate in concert with each other. The system may be incorporated in each of the personal computer, digital home appliance, photocopier, facsimile machine, scanner, printer, complex machine (serving at least two of the scanner, the printer, the photocopier, and the facsimile machine).

In the discussion of the exemplary embodiment, the record information managed in medical institutions is handled. The record information other than this type of information may be handled. For example, the record information of the exemplary embodiment may include record information handled in law firms, educational record information managed in education institutions and related to the education of students.

The above-described program may be supplied in a stored state on a recording medium. The program may be provided via a communication network. In such a case, the above-described program may be understood as an invention of a “computer readable recording medium storing the program.”

The “computer readable recording medium storing the program” refers to a computer readable recording medium storing the program, and used to install the program, to execute the program, or to distribute the program.

The recording media include digital versatile disk (DVD), compact disk (CD), Blu-ray disk (registered trademark), magnetooptical disk (MO), flexible disk (FD), magnetic tape, hard disk, read-only memory (ROM), electronically erasable and programmable read-only memory (EEPROM (registered trademark)), flash memory, and random-access memory (RAM). The DVDs include “DVD-R, DVD-RW, and DVD-RAM” complying with the standard formulated by the DVD forum, and “DVD+R and DVD+RW” complying with DVD+RW standards. The CDs include read-only CD (CD-ROM), recordable CD-R, and rewritable CD-RW.

The program in whole or in part may be stored on the recording medium for storage and distribution. The program in whole or in part may be transmitted via a transfer medium. The transfer media include a wired network, a wireless network, or a combination thereof. The wired networks include a local-area network (LAN), a metropolitan-area network (MAN), a wide-area network (WAN), the Internet, an intranet, and an extranet. The program in whole or in part may be transmitted over a carrier wave.

The program may be part of another program, or may be stored on the recording medium together with another program. The program may be split and split programs may then be stored on the recording medium. The program may be processed in any fashion before being stored. For example, the program may be compressed or encrypted before storage.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus, comprising:
a receiver unit that receives record information related to a record, the record including information about an item and time and date information about time and date on which the item has been preformed;
a classifying unit that classifies the record information received by the receiver unit into at least one of a plurality of series;
a standard event specifying unit that specifies a standard event on a per series basis, the standard event serving as a standard in the generation of a structure;
a structuring unit that performs a structuring operation on the record information, classified by the classifying unit, in accordance with the standard event specified by the standard event specifying unit;
a pattern extraction unit that extracts a common pattern from a plurality of pieces of record information that are structured in the structuring operation of the structuring unit; and
an output unit that outputs the pattern extracted by the pattern extraction unit.

2. The information processing apparatus according to claim 1, further comprising a linking unit that links a plurality of patterns, extracted by the pattern extraction unit, in accordance with the standard event specified by the standard event specifying unit,
wherein the output unit outputs the linking result provided by the linking unit.

3. The information processing apparatus according to claim 2, wherein in accordance with a relationship of the standard events, the linking unit links the patterns, extracted by the pattern extraction unit, and having the same set of items occurring within the patterns.

4. The information processing apparatus according to one of claim 2, wherein the linking unit links, to a position within the structure of the pattern of the standard event in the series, a partial structure positioned below the standard event of another pattern.

5. The information processing apparatus according to one of claim 3, wherein the linking unit links, to a location within the structure of the pattern of the standard event in the series, a partial structure positioned below the standard event of another pattern.

6. An information processing method, comprising:
receiving record information related to a record, the record including information about an item and time and date information about time and date on which the item has been preformed;
classifying the received record information into at least one of a plurality of series;
specifying a standard event on a per series basis, the standard event serving as a standard in the generation of a structure;
performing a structuring operation on the classified record information in accordance with the specified standard event;
extracting a common pattern from a plurality of pieces of record information that are structured in the structuring operation; and
outputting the extracted pattern.

7. A computer readable medium storing a program causing a computer to execute a process for processing information, the process comprising:
receiving record information related to a record, the record including information about an item and time and date information about time and date on which the item has been preformed;
classifying the received record information into at least one of a plurality of series;
specifying a standard event on a per series basis, the standard event serving as a standard in the generation of a structure;
performing a structuring operation on the classified record information in accordance with the specified standard event;
extracting a common pattern from a plurality of pieces of record information that are structured in the structuring operation; and
outputting the extracted pattern.
